(19) United States
(12) Patent Application Publication
(10) Pub. No.: US 2012/0097816 A1
(43) Pub. Date: Apr. 26, 2012

(54) Combination mounting and grounding clip

(75) Inventors: Don N. Tamm, Lafayette, CO (US); Richard F. Schaefer, Lafayette, CO (US); David Kreutzman, Lafayette, CO (US)

(73) Assignee: D THREE ENTERPRISES, LLC, Lafayette, CO (US)

(21) Appl. No.: 13/277,878

(22) Filed: Oct. 20, 2011

Related U.S. Application Data
(60) Provisional application No. 61/394,809, filed on Oct. 20, 2010.

(51) Int. Cl. F16M 13/00; B23P 11/00; F16B 2/20

(52) U.S. Cl. 248/309.1; 211/41.1; 29/466

(57) ABSTRACT

A clip for both mounting and grounding photovoltaic panels is disclosed. The clip has retention tabs which interact with mounting rails to fully support photovoltaic panels during installation. The interaction allows for adjustment along the length of the mounting rails. Interlocking fingers allow the mounting clips to fit together securely.

The interlocking nature of the mounting clips provides a secure fit between photovoltaic panels and requires less mounting hardware. Additionally, the interlocking nature of the mounting clips allows for security and stability of the photovoltaic panels during the mounting process, allowing a single installer to mount a number of photovoltaic panels. The use of serrated washers, or cutting edges on certain portions of the mounting clip provide grounding for the system by digging into both photovoltaic panels and mounting rails.

### CROSS REFERENCE APPLICATIONS

This application is a non-provisional application claiming the benefits of provisional application No. 61/394,809 filed Oct. 20, 2010, which is hereby incorporated by reference for all purposes.

### BACKGROUND

Clip mounting systems for photovoltaic and thermal panels are difficult and time consuming to install, and tend to be weak and failure prone. Setup of such systems generally requires at least two installers, one to hold the panel and one to attach it to the racking system. In addition to the racking system and solar panels, photovoltaic systems generally require additional components to provide electrical grounding.

The foregoing example of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

The combination photovoltaic and/or thermal panel mounting and grounding clip disclosed herein provides numerous advantages over previous photovoltaic and thermal panel mounting systems. First, it utilizes the photovoltaic panel manufacturers mounting holes, which preserves the warranty. The interlocking design of the clip allows a single installer to mount a photovoltaic system. The interlocking fingers keep the panels from dislodging from the roof before they have been secured with nuts and bolts. The clip's dual mounting and grounding function reduces the parts required and also reduces the installation time for a photovoltaic system. The clip's integral nose piece and the fact that it is bent into a failsafe catch to keep the panel from sliding off the roof is of significant value.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a perspective view of a mounting clip according to the present application.

FIG. 2 is a top plan view of the mounting clip of FIG. 1.

FIG. 3 is a front plan view of the mounting clip of FIG. 1.

FIG. 4 is a perspective view of a second embodiment of a mounting clip according to the present application.

FIG. 5 is a top plan view of the mounting clip of FIG. 3.

FIG. 6 is a front plan view of the mounting clip of FIG. 3.

FIG. 7 is a perspective view of a third embodiment of a mounting clip according to the present application.

FIG. 8 is a top plan view of the mounting clip of FIG. 7.

FIG. 9 is a front plan view of the mounting clip of FIG. 7.

FIG. 10 is an exploded view of the mounting clip of FIG. 1 attached to a photovoltaic panel.

FIG. 11 is a perspective view of the mounting clip of FIG. 1 attached to a photovoltaic panel.

FIG. 12 shows a photovoltaic panel being mounted on mounting rails.

FIG. 13 is a perspective view of the mounting clip of FIG. 1 mounted on a mounting rail.

FIG. 14 is an exploded view of the mounting hardware for attaching the mounting clip of FIG. 1 to a mounting rail.

FIG. 15 is a perspective view of two mounting clips fitting together.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

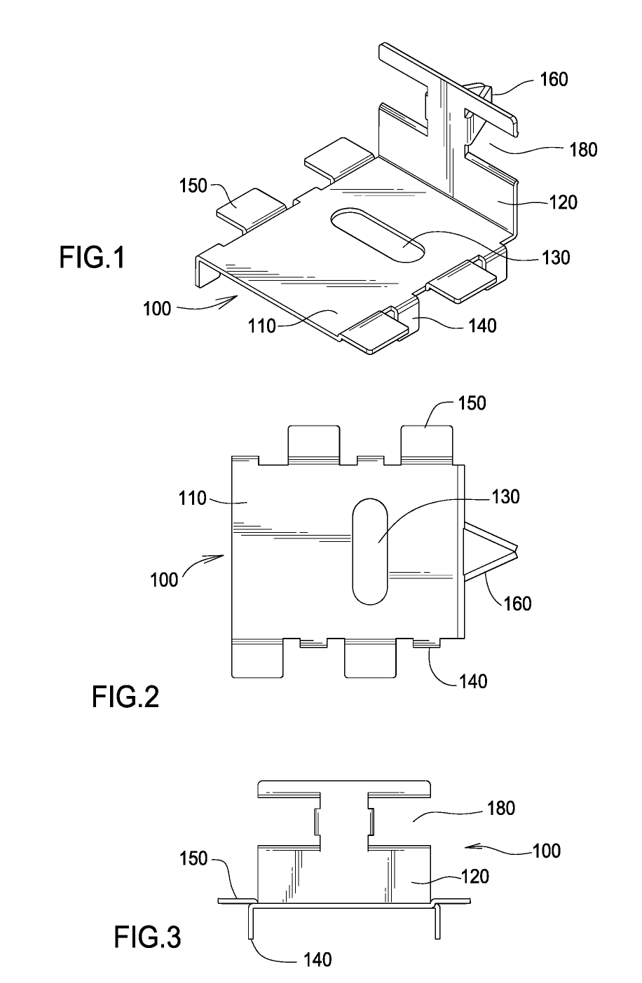

Turning first to FIGS. 1-3, mounting clip 100 includes a panel leg 110 and a rail leg 120. Panel leg 110 and rail leg 120 are perpendicular to one another. Panel leg 110 includes slot 130. In the depicted embodiment, slot 130 has a cutting edge. Mounting clip 100 also includes alignment flanges 140, interlocking fingers 150 and retention tabs 160. Alignment flanges 140 are substantially perpendicular to panel leg 110. Interlocking fingers 150 are substantially parallel to panel leg 110. Rail leg 120 includes retention tabs 160 and recesses 180. In the depicted embodiment, recesses 180 include a cutting edge. The width of panel leg 110 and rail leg 120 is designed to fit a variety of photovoltaic panel frame widths.

One skilled in the art will understand that interlocking fingers 150 can be of varying lengths. Interlocking fingers 150 can be equal in length or unequal in length. The length of interlocking fingers 150 may vary with a number of factors, including the manufacturing method used to make the part and the environment in which the mounting clip 100 will be used. Lengthening interlocking fingers 150 will provide a more secure fit, but also increases the raw material portion of the component cost. One having and ordinary level of skill in the art will understand that the longer interlocking fingers 150, the stronger and more secure the interaction of mounting clips 100, but making interlocking fingers 150 too long will not allow interaction between mounting clips 100. One skilled in the art will understand that the length of interlocking fingers 150 is proportional to the dimensions of mounting clip 100. Failure of mounting clips 100 to interact will occur when the proportions are altered too greatly.

In the depicted embodiment, mounting clip 100 comprises 16 gauge stainless steel and is stamped. While the depicted mounting clip 100 is stamped, it could be manufactured using other methods, such as laser or turret punch. While stainless steel is depicted, any material having similar strength and electrical conductive properties could be used. In the depicted embodiment, panel leg 110 measures approximately 65.09 mm tall and 49.21 mm wide. Rail leg 120 measures approximately 34.93 mm tall and 49.21 mm wide. At its widest points, slot 130 measures approximately 30.16 mm wide and 9.53 mm tall. Interlocking fingers 150 measure approximately 14.29 mm tall and approximately 15.88 mm wide. Alignment flanges 140 measure approximately 6.35 mm tall and 9.53 mm wide. Recesses 180 measure approximately 14.29 mm wide and 11.11 mm tall. Retention tabs 160 measure approximately 14.29 mm wide and 9.53 mm tall. The measurements depicted herein are merely exemplary, and should not be considered limiting.

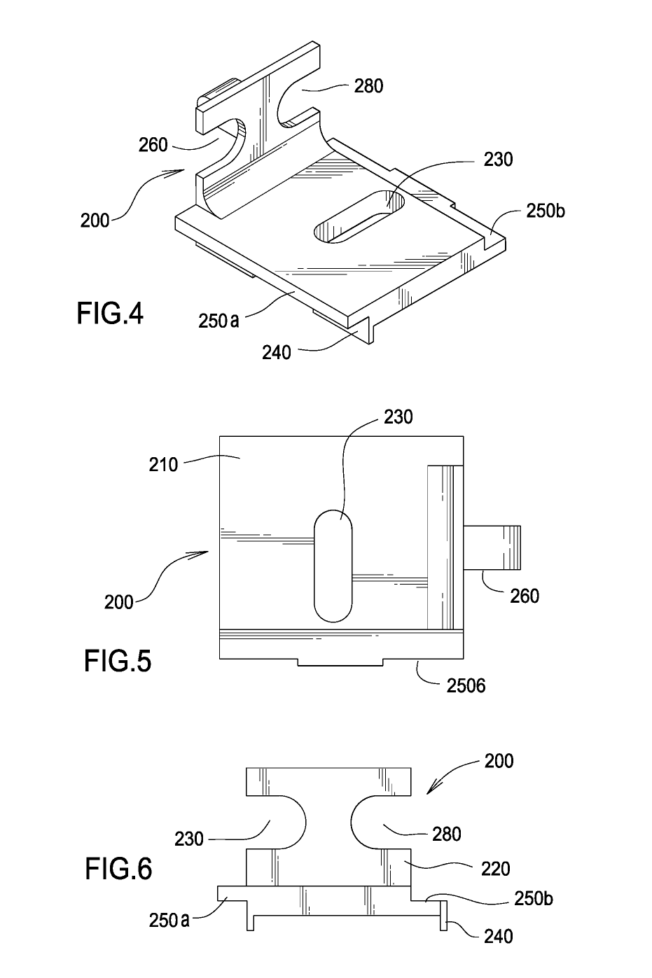

Turning next to FIGS. 4-6, a second embodiment of mounting clip 200 is shown. Mounting clip 200 includes a panel leg 210 and a rail leg 220. Panel leg 210 and rail leg 220 are perpendicular to one another. Panel leg 210 includes slot 230. Mounting clip 200 also includes alignment flanges 240, interlocking fingers 250a, 250b and retention tabs 260. Alignment flanges 240 are substantially perpendicular to panel leg 210. Interlocking fingers 250 are substantially parallel to panel leg 210. Rail leg 220 includes retention tabs 260 and recesses 280. The width of panel leg 210 and rail leg 220 is designed to fit a variety of photovoltaic panel frame widths.

In the depicted embodiment, mounting clip 200 comprises aluminum and is formed by extrusion. While aluminum is depicted, any material having similar strength and electrical conductive properties could be used.

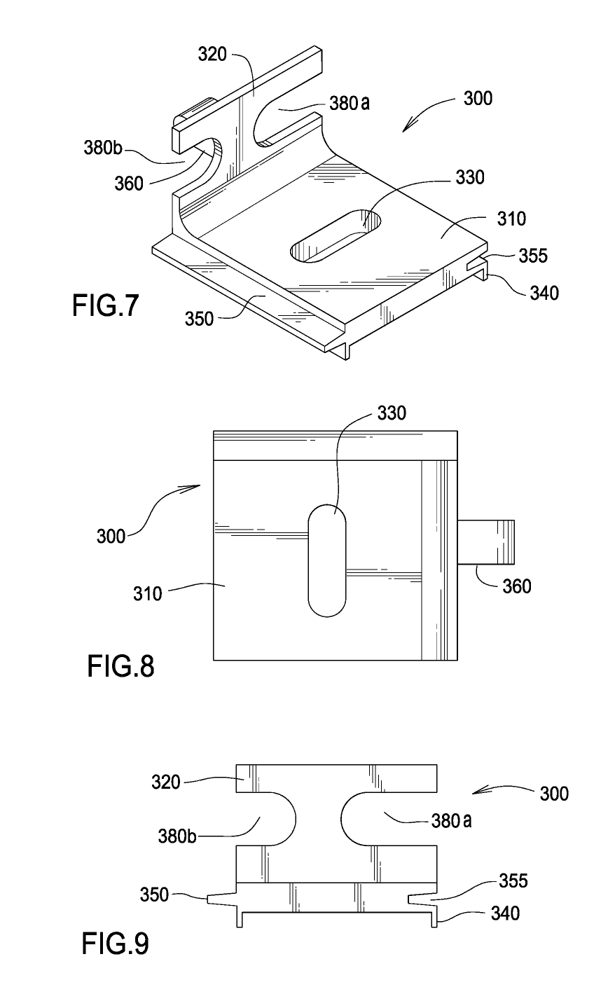

Turning next to FIGS. 7-9, a third embodiment of mounting clip 300 is shown. Mounting clip 300 includes a panel leg 310 and a rail leg 320. Panel leg 310 and rail leg 320 are perpendicular to one another. Panel leg 310 includes slot 330. Mounting clip 300 also includes alignment flange 340, interlocking element 350, interlocking receptacle 355 and retention tabs 360. Alignment flanges 340 are substantially perpendicular to panel leg 210. Interlocking element 350 and interlocking receptacle are substantially parallel to panel leg 310. Rail leg 320 includes retention tabs 360 and recesses 380. Recesses 380 are offset, such that recess 380a is larger than 380b. The width of panel leg 310 and rail leg 320 is designed to fit a variety of photovoltaic panel frame widths.

In the depicted embodiment, mounting clip 300 comprises aluminum and is formed by extrusion. While aluminum is depicted, any material having similar strength and electrical conductive properties could be used.

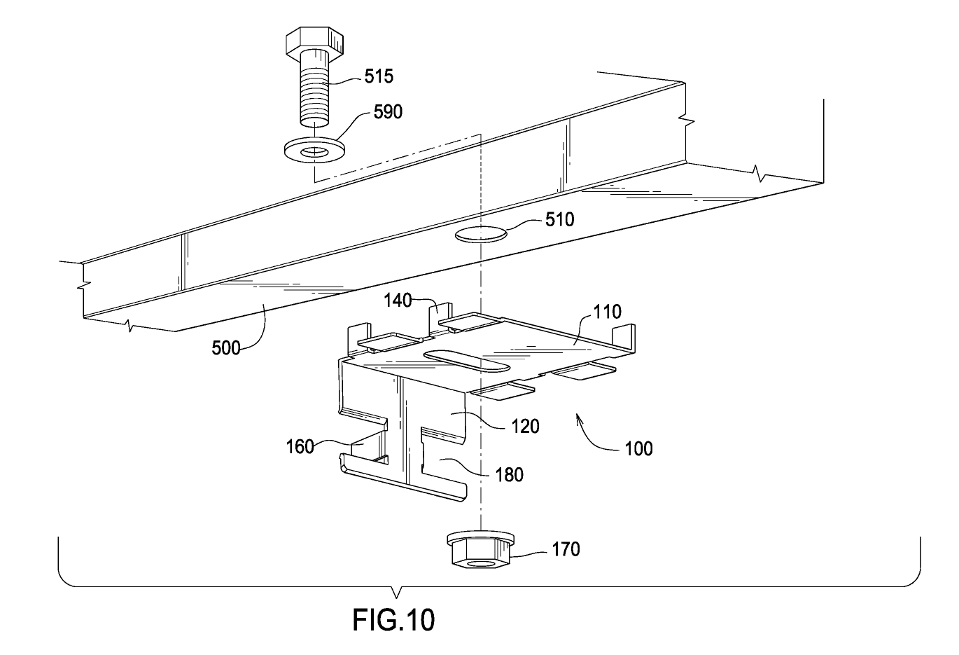

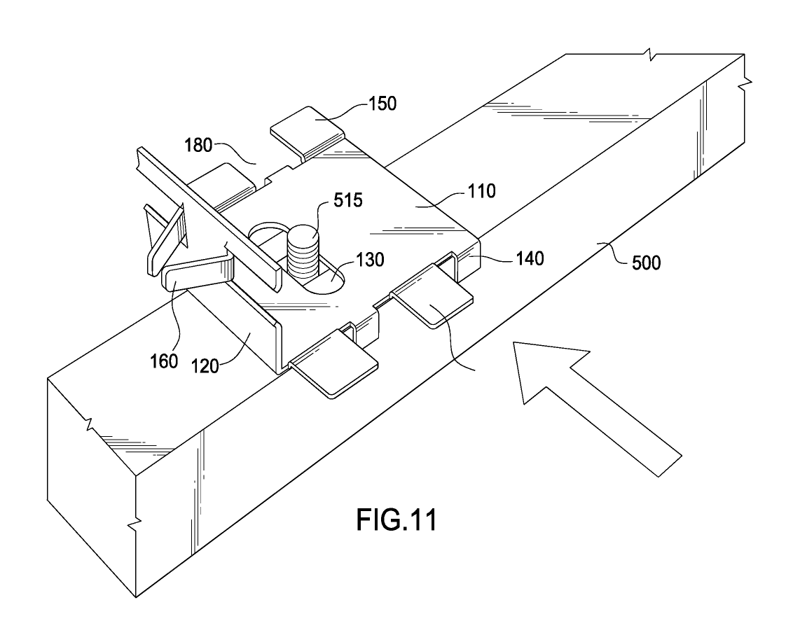

Turning next to FIGS. 10-11, a mounting clip 100 is attached to a photovoltaic panel 500. While mounting clip 100 is discussed as the exemplary mounting clip, any of the previously discussed mounting clips could be used. Photovoltaic panel 500 is placed face down on a solid protective surface, exposing mounting holes 510. A user selects two parallel mounting holes along the length of photovoltaic panel 500. In the depicted embodiment, the mounting holes are approximately ⅓ of the length from each end of photovoltaic panel 500. However, the mounting holes can be wherever the manufacturer of the photovoltaic panels has placed holes. Utilizing the manufacturer's mounting holes preserves the manufacturer's warranty for the photovoltaic panel because mounting clips 100 utilize the manufacturer's specified mounting locations.

A mounting clip 100 is loosely mounted in each of the mounting holes 510 with a bolt 515. In the depicted embodiment, a flat washer 590 is placed between bolt 515 and the inside edge of the frame of photovoltaic panel 500. In the depicted embodiment, bolt 515 is a 5/16″-18×¾″ hex bolt. In the depicted embodiment, flat washer 590 is a 5/16″-18 flat washer. Optionally, a star washer can be placed on bolt 515 to rest against the frame of photovoltaic panel 500 in order to provide ground to the photovoltaic panel 500. Star washer can be a 5/16″ double cut star washer, for example. Slot 130 of mounting clip 100 is placed over bolt 215. A nut 170 captures bolt 515. In the depicted embodiment, a 5/16″-18 serrated flange nut is used. Clip 100 is then adjusted within mounting slot 510a so the clip 100 is as close to the top edge of photovoltaic panel 500 as possible. This adjustment ensures all photovoltaic panels 500 will be mounted evenly with respect to one another and align well within the array. Mounting clip 100 is oriented so alignment flanges 140 are flush against the outside edge of photovoltaic panel 500 and rail leg 120 is facing what will be the bottom edge of photovoltaic panel 500. Once mounting clip 100 is properly oriented, bolt 515 is forced flush with the bottom edge of slot 130 and tightened. In the depicted embodiment, a 19 foot pounds wrench is used to tighten bolts. This process is then repeated on the opposite side of photovoltaic panel 500. In the depicted embodiment, mounting holes 510f and 510g would be used to mount two additional mounting clips 100. Each photovoltaic panel 500 must have a total of four mounting clips 100 installed.

In an alternate embodiment, slot 130 and recesses 180 have cutting edges, which dig into photovoltaic panel 500. The cutting edges of slot 130 and recesses 180 dig into the metal frame of photovoltaic panel 500. The interaction of the cutting edges of mounting clip 100 and photovoltaic panel 500 ground the photovoltaic panel 200. The cutting edges of slot 130 and recesses 180 eliminate the need for a star washer as described above.

The steps for attaching mounting clips 100 to the photovoltaic panels 500 are repeated until all photovoltaic panels 500 have four mounting clips 100 attached. It should be noted that mounting clips 100 can be mounted while photovoltaic panels 500 are on the ground or in a warehouse, thereby allowing an installer to mount photovoltaic panels 500 more quickly and easily.

Once mounting clips 100 are installed on all photovoltaic panels 500, several measurements are taken to prepare for mounting on mounting rails 520. First, distance D1 is measured. D1 is the distance between the lower surface L1 of rail leg 120a to the lower surface L2 of rail leg 120b. D1 is the rail spacing for mounting photovoltaic panel 500 to mounting rails 520.

Second, distance D2 is measured. Distance D2 is the distance from the top T1 of mounting rail 520a to the top T2 of mounting rail 520b. Distances D1 and D2 should be the same. An installer may measure distance D2 at a number of places along mounting rails 520a and 520b to ensure D2 remains constant.

Third, distances D3 and D4 are measured. Distance D3 is the distance between the lower surface L1 of rail leg 120a and the top edge T of photovoltaic panel 500. Distance D4 is the distance between the lower surface L2 of rail leg 120b and the bottom edge B of photovoltaic panel 500.

If multiple rows of photovoltaic panels are to be installed, one final measurement is taken. Mounting rails 520 should be spaced to accommodate the distance between rows of photovoltaic panels 500. This distance is equal to the D4 dimension of the top row of photovoltaic panels plus the desired gap between rows plus the D3 dimension of the bottom row of photovoltaic panels.

One having an ordinary level of skill in the art will understand that the D1, D2, D3 and D4 measurements need not be made in the order presented.

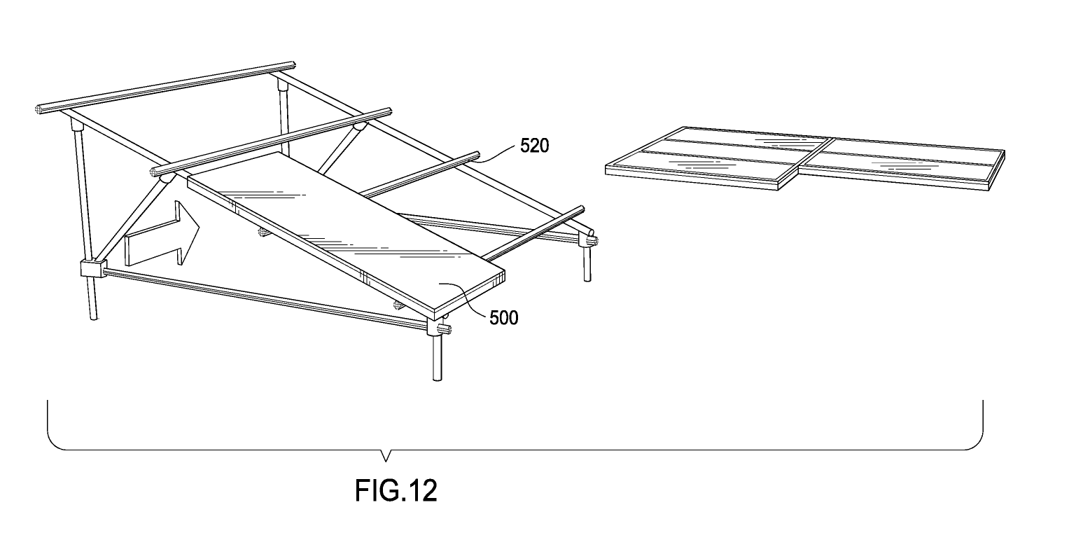

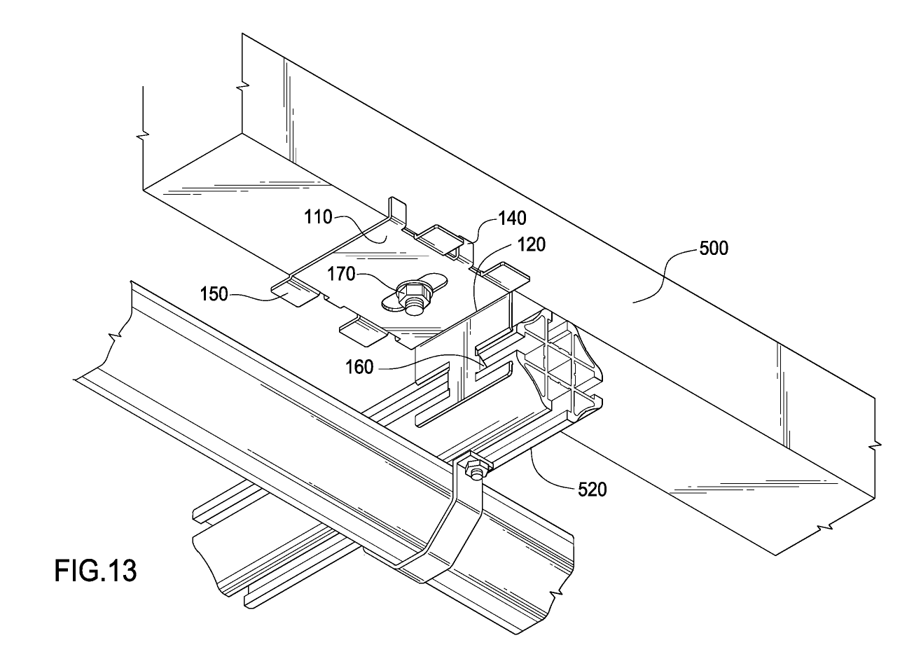

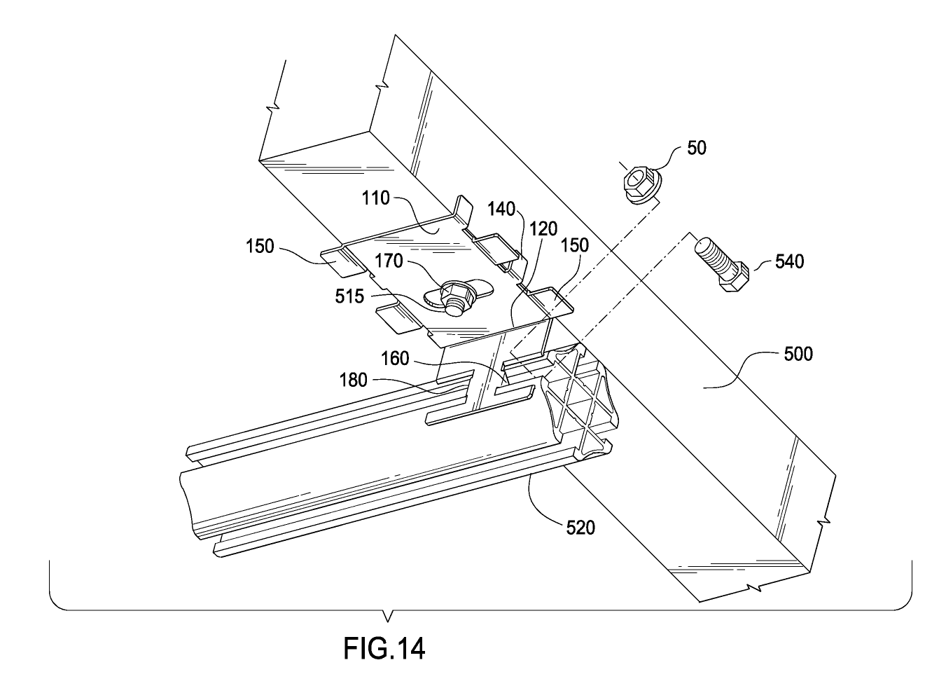

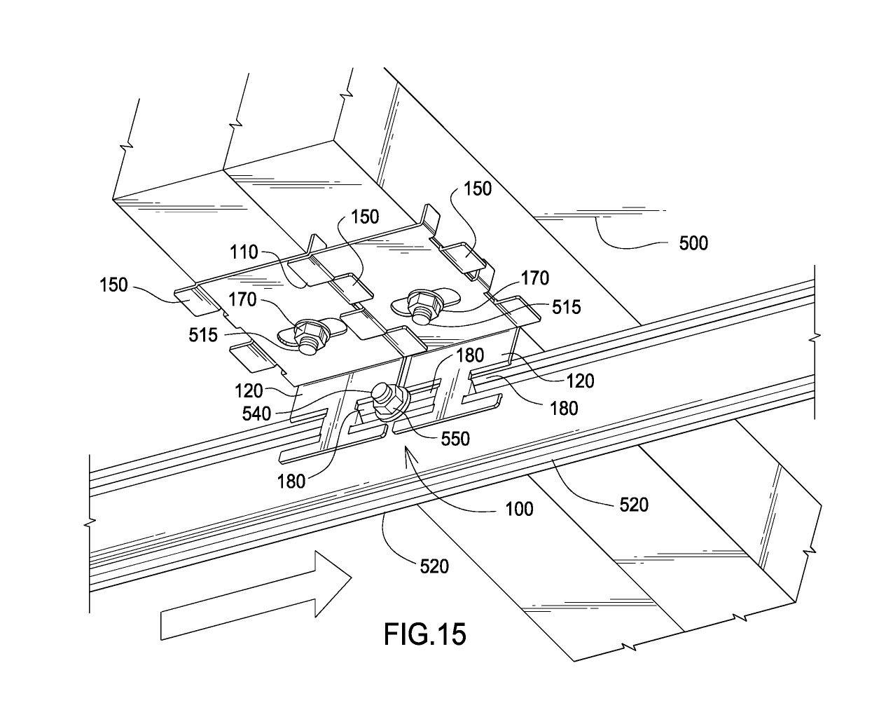

Turning next to FIGS. 12-15, once it has been determined that mounting clips 100 and mounting rails 520 are properly spaced, the photovoltaic panels 500 are mounted. Starting with the bottom row on either side of the array, an appropriate number of bolts 540 is inserted into the top side of the channel 530 of each mounting rail 520. Two bolts 540 are used per mounting rail 520 for the first photovoltaic panel 500, one bolt 540 per mounting rail 520 for each subsequent photovoltaic panel 500. A photovoltaic panel 500 is hung on mounting rails 520a and 520b. Rail legs 120 of mounting clips 100 sit on top of mounting rail 520. Retention tabs 160 fit inside channel 530. The interlocking fit of rail leg 120 and mounting rail 520 allows the back face of photovoltaic panel 500 to sit flush with mounting rails 520, thereby providing a tight fit and low profile. Photovoltaic panel 500 is now stable on mounting rails 520 and does not require any further support to stay in place.

Photovoltaic panel 500 can then be adjusted by sliding it in either direction in channel 530 until it is in the proper position. Once photovoltaic panel 500 is in the proper position, it can be secured to mounting rails 520. A bolt 540 is inserted into channel 530 outside recesses 180. Preferably, all necessary bolts 540 are inserted into channel 530 prior to placing photovoltaic panels 500 on mounting rails 520. However, bolts 540 can also be added throughout to mounting process. Optionally, a star washer can be placed over bolt 540 so that it rests on top of mounting rail 220. Mounting clips 100 are lifted slightly as bolts 540 are moved along channel 530 into recesses 180. If a star washer is used, the star washer should be between mounting rail 520 and mounting clip 100. Each bolt 540 is concurrently pushed and twisted 45° to lock it into channel 530. A flange nut 550 is placed over each bolt 540 and locked into place with a socket wrench. In the depicted embodiment, bolt 540 is a ⅜″-16×1″ hex bolt. In the depicted embodiment, nut 550 is ⅜″-16 serrated flange nut. In the depicted embodiment, a 33 foot pound open end wrench is used to lock nut 550 in place. Alternatively, a lock washer and nut can be placed over bolt 540. One having ordinary skill in the art will understand that numerous equivalents having similar strength and size exist for each of these parts, and that such equivalents are included in this disclosure.

In an alternate embodiment, recess 180 has cutting edges, which dig into mounting rail 520. The cutting edges of recess 180 eliminate the need for a star washer as described above.

Cutting edges of recess 180, or the optional star washer discussed above, dig into mounting rail 520. At the same time, cutting edges of slot 130, or the optional star washer discusses above, cut into photovoltaic panel 500. This configuration creates a ground between photovoltaic panels 500 and mounting rails 520 throughout the entire array.

The first photovoltaic panel 500 requires four bolts 540 to secure it to mounting rails 520. Each subsequent photovoltaic panel 500 requires only two bolts 540 to secure it to mounting rails 520. When mounting clips 100 are installed on adjacent photovoltaic panels 500, interlocking fingers 150 fit together and lock. The interlocking mounting clips 100 allow an installer to attach only one mounting clip 100 to each mounting rail 520. Once the first photovoltaic panel 500 is installed, subsequent photovoltaic panels 500 are mounted by placing the photovoltaic panel 500 on mounting rails 520 so that retention tabs 160 fit inside channel 530 and sliding the interlocking fingers 150 of mounting clips 100 together. Two bolts 540 are used to secure the mounting clips 100 that lay exposed. This process is continued until all photovoltaic panels 500 are installed.

If multiple rows of photovoltaic panels 500 are installed, the bottom row is installed first, followed by the next highest row.

Mounting clips 100 allow the photovoltaic panels to be mounted close together, approximately 0.0625 inches apart. Among the advantages of this close fit is the ability to mount more panels in a limited space. Another advantage is an architecturally attractive end result. Since gaps between the photovoltaic panels are not significantly visible, the set of panels look like one piece of glass versus a mosaic of various panels. Further, because mounting clips 100 are mounted into existing holes in the photovoltaic panels, and not to the tops and ends of photovoltaic panels as is often done in the industry, snow and ice can slide off the photovoltaic panels without catching on top clips or protrusions above the glass.

The structure of mounting clips 100 provides many advantages both during and after the mounting process. Interlocking fingers 150 keep photovoltaic panels 500 from dislodging from the roof both during the installation process and after installation. Rail leg 120 also keeps photovoltaic panels 500 from dislodging from the roof once it is inserted in mounting rail 520. The shape of mounting clip 100, particularly the 90 degree bend between panel leg 110 and rail leg 120 keep photovoltaic panels 500 from sliding off the roof and to the ground. Retention tabs 160 catch the mounting rails 520, further preventing photovoltaic panels 500 from dislodging from the roof. The sharp edges in mounting clips 100 create an electronic ground by cutting into both the photovoltaic panels 500 and the mounting rail 520, effectively creating a ground and obsolescing ground screws or ground lugs that are currently being used to perform this duty.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and contexts known to those skilled in the art. The above definitions are provided to clarify their specific use in the context of the invention.

All patents and publications mentioned in the specification are indicative of the levels of skill of those skilled in the art to which the invention pertains. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

I claim:

1. A mounting clip comprising:
a panel leg;
a rail leg;
said panel leg further comprising a slot and interlocking elements extending there from,
said interlocking elements can interlock with interlocking elements of a second substantially similar mount clip; and
said rail leg further comprising retention tabs and recesses.

2. The mounting clip of claim 1, wherein said panel leg further comprises alignment flanges.

3. The mounting clip of claim 1, wherein said slot includes a cutting edge.

4. The mounting clip of claim 1, wherein said recesses include a cutting edge.

5. The mounting clip of claim 1, wherein said recesses are approximately the same size.

6. The mounting clip of claim 1, wherein said recesses are different sizes.

7. The mounting clip of claim 1, wherein said interlocking elements are substantially parallel to the panel leg.

8. The mounting clip of claim 1, wherein said interlocking elements comprise an interlocking element and an interlocking receptacle.

9. The mounting clip of claim 1, wherein said mounting clip comprises stainless steel.

10. The mounting clip of claim 1, wherein said mounting clip comprises aluminum.

11. The mounting clip of claim 1, wherein said mounting clip is formed by stamping.

12. The mounting clip of claim 1, wherein said mounting clip is formed by extrusion.

13. A mounting clip for photovoltaic panels comprising:
panel leg means for attaching to a photovoltaic panel;
rail leg means for connecting said panel leg means to a mounting rail;
interlocking means for connecting said mounting clips together;
retention means for attaching said rail leg means to said mounting rail;
said panel leg means further comprising slot means for attaching to said photovoltaic panels; and
said rail leg means further comprising recess means for attachment to said mounting rail.

14. The mounting clip of claim 13, further comprising alignment means for aligning said panel leg means on said photovoltaic panel.

15. The mounting clip of claim 13, wherein said interlocking means comprises interlocking fingers.

16. The mounting clip of claim 13, wherein said interlocking mean comprise an interlocking element and an interlocking recess.

17. The mounting clip of claim 13, further comprising grounding means for grounding said photovoltaic panel to said mounting rail.

18. The grounding means of claim 17, further comprising a serrated washer.

19. The grounding means of claim 17, further comprising a cutting edge on said mounting clip at the point of attachment to said photovoltaic panel.

20. The grounding means of claim 17, further comprising a cutting edge on said mounting clip at the point of attachment to said mounting rail.

21. A method for mounting a photovoltaic panel comprising the steps of:
attaching a set of mounting clips to a frame of a first photovoltaic panel;
said first photovoltaic panel having at least a first mounting clip and a second mounting clip;
said mounting clips having interlocking members;
placing said first photovoltaic panel onto a set of mounting rails;
sliding said first photovoltaic panel into place on said mounting rails;
attaching said first photovoltaic panel to said mounting rail through said first mounting clip and said second mounting clip;
placing a second photovoltaic panel on said mounting rails;
said second photovoltaic panel having at least a third mounting clip and a fourth mounting clip;
sliding said second photovoltaic panel into place next to said first photovoltaic panel so that said interlocking members of said third mounting clip interact with said interlocking members of said second mounting clip; and
attaching said second photovoltaic panel to said mounting rail through said fourth mounting clip.

22. The method of claim 20, further comprising the step of mounting additional photovoltaic panels after said second photovoltaic panel.

23. The method of claim 20, further comprising the step of mounting a second row of photovoltaic panels above the first row of photovoltaic panels.

24. The method of claim 20, further comprising the step of including a serrated washer when attaching said mounting clip to said photovoltaic panel.

25. The method of claim 20, further comprising the step of including a serrated washer when attaching said mounting clip to said mounting rail.

26. The method of claim 20, wherein said mounting clip includes cutting edges at the point of attachment to said photovoltaic panel.

27. The method of claim 20, wherein said mounting clip includes cutting edges at the point of attachment to said mounting rail.
